(19) United States
(12) Patent Application Publication
(10) Pub. No.: US 2025/0162836 A1
(43) Pub. Date: May 22, 2025

(54) METHOD AND APPARATUS FOR DETECTING SELF-LOCK FUNCTION OF ONE OR MORE LANDING DOORS

(71) Applicant: Otis Elevator Company, Farmington, CT (US)

(72) Inventors: Qing Wu, Shanghai (CN); Jingri Nan, Shanghai (CN); Haiyang Li, Shanghai (CN); Xiaobin Tang, Tianjin (CN); Xiaping Qiu, Shanghai (CN); Lingfeng Hou, Shanghai (CN); Jialiang Gu, Shanghai (CN)

(21) Appl. No.: 18/953,611

(22) Filed: Nov. 20, 2024

(30) Foreign Application Priority Data
Nov. 22, 2023 (CN) 202311568881.2

(51) Int. Cl. B66B 5/00; B66B 13/14

(52) U.S. Cl. CPC B66B 5/0031; B66B 13/143

(57) ABSTRACT

A method and device for detecting an automatic closing function of one or more landing doors, and a non-transitory computer-readable storage medium. In the method, a state variable of a drive mechanism of the car door when a car door of a car moves in a uniform linear motion alone is first obtained, and subsequently a state variable of the drive mechanism of the car door when the car door and a landing door to be detected move in a uniform linear motion during a closing process is obtained. The state variable is suitable for determining a driving force applied by the drive mechanism of the car door to the car door. Subsequently, automatic closing capability of the landing door to be detected is determined based on the force applied by an automatic self-closing device of the landing door and the resistance of the landing door during a separate movement.

### FOREIGN PRIORITY

This application claims priority to Chinese Patent Application No. 202311568881.2, filed Nov. 22, 2023, and all the benefits accruing therefrom under 35 U.S.C. § 119, the contents of which in its entirety are herein incorporated by reference.

### TECHNICAL FIELD OF INVENTION

The present application relates to elevator technology and, in particular, to a method and device for detecting an automatic closing function of one or more landing doors, and a non-transitory computer-readable storage medium storing a computer program for implementing the method.

### BACKGROUND OF THE INVENTION

When a landing door is not properly closed and a car is not in a proper position for that floor, the landing door will be locked or closed automatically with the help of a self-locking function or an automatic closing function to reduce the risk of accidents. Currently, the check of the automatic closing function of the landing door is still manually completed. For example, maintenance personnel regularly or irregularly test the automatic closing function of the landing door on each floor one by one to determine whether its function is normal. The check work will take a large amount of labor and time, especially for elevator systems operating in high-rise and ultra-high-rise buildings.

### SUMMARY OF THE INVENTION

In accordance with an aspect of the present application, there is provided a method for detecting an automatic closing function of one or more landing doors. In the method, a state variable of a drive mechanism of the elevator system is first obtained when a car door of a car of an elevator system and a landing door to be detected move in a uniform linear motion during a closing process. The state variable is suitable for determining a driving force applied by the drive mechanism to the car door and the landing door to be detected. Subsequently, automatic closing capability of the landing door to be detected is determined based on the driving force applied during the uniform linear motion and resistance to which the car door is subjected when traveling.

Optionally, the method further comprises: determining whether the elevator system is suitable for entering or being in a detection mode, and if so, performing steps A and B.

Optionally, the method further comprises: sending a detection result regarding the automatic closing capability of the landing door to be detected to a cloud platform or a mobile terminal.

In the method, steps A and B are performed for a plurality of landing doors in a specified order.

Optionally, in the method, step A comprises: A1. when the car stops at one of a plurality of floors corresponding to the landing door to be detected, opening the car door of the car and the landing door to be detected; A2. causing the car door and the landing door to be detected to move in the uniform linear motion during the closing process by controlling the driving force applied by the drive mechanism to the car door and the landing door to be detected.

Optionally, in the method, step A comprises receiving, from the elevator system, the state variable of the drive mechanism when the car door and the landing door to be detected move in the uniform linear motion.

Optionally, in the method, step A comprises: A3. Receiving, from the elevator system, state variables of the drive mechanism under various motion states of the car door and the landing door to be detected; A4. extracting the state variable when the car door and the landing door to be detected move in the uniform linear motion from the state variables under the various motion states.

Optionally, step B is performed at any of the following locations: a cloud platform, an elevator controller, a door controller and a mobile terminal.

Optionally, in the method, a speed of the uniform linear motion is controlled in a range of 20 mm/sec to 80 mm/sec.

Optionally, in the method, the drive mechanism is a motor, and in step A2, the uniform linear motion of the car door and the landing door to be detected is realized by causing the motor to work in a constant-speed output mode.

Optionally, in the method, the state variable when the car door and the landing door to be detected move in the uniform linear motion and the state variable under various motion states are an induced current or an output torque of the motor.

Optionally, in the method, the resistance is determined in the following manner: decoupling the car door and the landing door to be detected from mechanical coupling; placing the car door in a state of the uniform linear motion by controlling the driving force applied by the drive mechanism to the car door; and determining the resistance based on the driving force applied to the car door in the state of the uniform linear motion.

Optionally, in the method, the automatic closing capability is measured in terms of a net force applied to the landing door to be detected. Further, in step B, the automatic closing capability of the landing door to be detected is determined in the following manner: B1. determining, from the state variable, the driving force applied by the drive mechanism when the landing door to be detected moves in the uniform linear motion; B2. determining the net force based on the driving force applied by the drive mechanism when the landing door to be detected moves in the uniform linear motion and the resistance to which the car door is subjected when traveling; and B3. determining that the landing door to be detected can be closed normally if the net force is greater than or equal to a preset value, otherwise determining that the landing door to be detected cannot be closed normally.

Optionally, in the method, an average value of the driving force applied by the drive mechanism at a plurality of moments when the car door and the landing door to be detected move in the uniform linear motion is used as the driving force for determining the net force.

In accordance with another aspect of the present application, there is provided a device for detecting an automatic closing function of one or more landing doors. The device comprises at least one memory, at least one processor coupled with the memory and a computer program stored on the memory and running on the processor. The running of the computer program results in the following operations: A. obtaining a state variable of a drive mechanism of the elevator system when a car door of a car of an elevator system and a landing door to be detected move in a uniform linear motion during a closing process, the state variable being suitable for determining a driving force applied by the drive mechanism to the car door and the landing door to be detected; B. determining automatic closing capability of the landing door to be detected based on the driving force applied during the uniform linear motion and resistance to which the car door is subjected when traveling.

In accordance with a further aspect of the present application, there is provided a computer-readable storage medium on which a computer program suitable for running on a processor of a terminal device is stored, the running of the computer program resulting in the steps of the method as described above being performed.

### BRIEF DESCRIPTION OF THE DRAWINGS

The above and/or other aspects and advantages of the present application will be clearer and more easily understood from the following description of various aspects in conjunction with the accompanying drawings, in which the same or similar units are denoted by the same reference numerals. The accompanying drawings include:

FIG. 1 is a flowchart of a method for detecting an automatic closing function of a landing door in accordance with some embodiments of the present application.

FIG. 2 is a flowchart of a method for detecting an automatic closing function of a landing door in accordance with some other embodiments of the present application.

FIG. 3 is a flowchart of a method for detecting an automatic closing function of a landing door in accordance with some other embodiments of the present application.

FIG. 4 is a flowchart of a method for detecting an automatic closing function of a landing door in accordance with some other embodiments of the present application.

FIG. 5 is a schematic block diagram of a device for detecting an automatic closing function of a landing door in accordance with some other embodiments of the present application.

### DETAILED DESCRIPTION OF THE INVENTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly or clearly stated in the specification and claims.

In this specification, “closing process” refers to a process in which a car door or landing door begins to move until it is normally closed or reaches a closed state. During the closing process, the car door or landing door gradually decreases a gap between the doors. During the closing process, the car door or landing door gradually decreases the gap between the doors until it is normally closed. The normal closing described herein refers to the car door or landing door being completely closed without gaps or openings. It should be noted that the gap described herein may refer to the gap between door leaves (when the door contains multiple door leaves), or may refer to the gap between door leaf and door frame (when the door only contains one door leaf).

In this specification, “automatic closing function of a landing door” refers to a function that causes the landing door to close, prohibits the opening of the landing door, or locks the landing door when an elevator system is in a specific state (e.g., when the car is not on this floor and the landing door is completely closed). It should be noted that the implementation of the automatic closing function of the landing door is dependent on a cooperative operation of multiple levels and multiple components. For example, in the case of the landing door of the elevator system, a control device (e.g., a door controller or elevator controller) monitors the state of each landing door and the position of the car, and determines the timing of locking the landing door based on the monitoring information; for example, a door sensor or door lock switch is responsible for transmitting the state signal of the landing door (e.g., a door closing in place signal) to the control device; and for example, an executing mechanism is a key component that usually executes actions to close, lock, or unlock the landing door based on instructions from the control device. This means that any abnormal operation of any level or component may result in abnormal automatic closing function of a landing door. For example, spring aging or loss of counterweight will make the driving force no longer exist, foreign objects inside the door guide rail will impede the door movement, and friction will increase when the door wheels are adhering to oil, all of which will cause the door not to close normally.

The specific structure and working principle of the executing mechanism may vary depending on the elevator manufacturer and product model, and the executing mechanism usually includes components such as a spring device and/or a counter weight for ensuring normal operation of the self-locking function or the automatic closing function. For example, in a typical executing mechanism, when the landing door is in a closed state, the spring will apply a certain force to the landing door to drive it into a completely closed state and keep it tightly closed. Counter weight is another component in the executing mechanism, which uses gravity to drive the landing door into a completely closed state and keep it locked. A separate counter weight or spring may usually be configured for each landing door.

During the closing process, the drive mechanism of the elevator system Type equation here. drives the movement of the car door and landing door. A drive mechanism such as a motor or a hydraulic system may usually be utilized to provide the force or driving force for driving the movement of the car door and landing door. In addition to the driving force from the drive mechanism, the force applied to the landing door by the executing mechanism described above (e.g. spring device, counter weight, etc.) also plays an auxiliary role in the closing of the landing door. When the combined force of the driving force and the auxiliary force is sufficiently large, the resistance (e.g. the friction between the car door and the landing door and the door frame) of the car door and the landing door may be overcome to close the car door and the landing door. When the car door and the landing door move as a whole, they have the following dynamic equation:

$${F}_{1} - {f}_{landing} + {f}_{car} = ma \qquad ( 1 )$$

In the above equation, it is assumed that the force takes a positive value along the closing direction and a negative value along the opening direction, F₁ is the force applied to the landing door by the executing mechanism, F₂ is the driving force applied by the drive mechanism to the car door and the landing door, f_{landing} is the resistance (e.g. the friction between the landing door and the door frame) to which the landing door is subjected in the process of traveling, f_{car} is the resistance (e.g. the friction between the car door and the door frame) to which the car door is subjected in the process of traveling, m is the sum of the masses of the car door and the landing door, and a is the acceleration of the car door and the landing door as a whole.

The inventors of the present application have found through research that there is a significant correlation between the magnitude of the net force Fₙₑₜ (which is equal to F₁−f_{landing}) applied to the landing door and the automatic closing capability of the landing door (the automatic closing capability determines whether the landing door can be auto-closed or whether the automatic closing function is normal or not). In some embodiments of the present application, the net force applied to the landing door is utilized as a measure of this automatic closing capability. Further, the judgment may be based on a single threshold value, i.e., the net force Fₙₑₜ is compared to a preset value TH, and when the former is greater than or equal to the latter, it is judged that the landing door can be closed normally, and vice versa, it is judged that the landing door cannot be closed normally. The above preset value TH may be determined based on a field experiment or a simulation experiment. It is to be noted that the research of the inventors of the present application has shown that a single threshold value is already sufficient to make a good differentiation between the normal or not normal of the automatic closing function, and has a low false alarm rate and a low omission rate for the function abnormality event. This is favorable for the simplification of the judgment logic.

The automatic closing function detection method described above is not only applicable to a single landing door, but may also be applied to multiple landing doors. For example, the detection of the automatic closing function of the landing door of each landing door may be executed sequentially in accordance with the order in the list of landing doors to be maintained, in accordance with the detection method described above, until all landing doors in the list have completed the detection operation. It is to be noted that the order in which the detection is executed may be various specified orders, such as a floor order including a landing door from the 1st floor to the nth floor or a landing door from the nth floor to the 1st floor, or an order obtained by randomly selecting from the landing doors of the 1st to the nth floors. Furthermore, the above-described detection method is also applicable to the case where a floor contains a plurality of landing doors, in which case a corresponding device identification may be assigned to each of the landing doors to distinguish the landing doors from each other.

In some embodiments, in order to determine the net force Fₙₑₜ, the car door and the landing door may be caused to move in a uniform linear motion during a closing process by controlling the driving force of the drive mechanism. In a state of the uniform linear motion, the above equation (1) may be rewritten as:

$${F}_{net} = {F}_{1} - {f}_{landing} = - {F}_{2} + {f}_{car} \qquad ( 2 )$$

In the above equation (2), the driving force F₂ applied by the drive mechanism to the car door and the landing door may be determined according to the state variables of the drive mechanism. Taking the motor as an example, since the induced current of the motor has a correspondence (e.g., proportionality) with the output torque, the driving force F₂ applied by the motor to the car door and the landing door may be obtained from the induced current as a state variable. For example, the output torque of the motor may also be used as a state variable.

In addition, the resistance F_{car} in equation (2) above may be experimentally determined or calibrated. For example, in some embodiments, it is possible to decouple the car door and the landing door from mechanical coupling (i.e., so that the landing door does not move under the drive of the car door), and at this time, the driving force F₂ of the drive mechanism acts only on the car door. By adjusting the driving force of the drive mechanism so that the car door moves in a uniform linear motion, the resistance f_{car} to which the car door is subjected may be determined (e.g., the driving force applied by the drive mechanism in a uniform linear motion may be determined as the resistance f_{car}). It should be noted that the inventors of the present application have found, after research, that for the same car door, it remains substantially constant or changes very little at various speeds of movement and at various positions of the car door, which makes it possible to determine the resistance without taking into account the influence of factors such as the speed of movement and the position, thus determining the resistance of the car door in an efficient and concise manner. In further embodiments, the resistance f_{car} may be calibrated regularly or irregularly in the manner described above to reflect changes in the performance of the car door (e.g. changes in friction due to car door wear, etc.).

Various ways may be used to realize a uniform linear motion of the car door and the landing door by controlling the driving force applied by the drive mechanism to the car door and the landing door. Taking the drive mechanism as the motor for example, the motor usually has a constant-speed output mode, in which the induced current of the motor is adjusted based on a control algorithm such as PID to cause the car door and the landing door to move in a uniform linear motion. Typically, controlling the speed of movement of the car door and the landing door at a low level is advantageous for improving the accuracy of the determination of the automatic closing capability of the landing door. Exemplarily, a speed of the uniform linear motion of the landing door and the car door may be controlled in the range of 20 mm/sec to 80 mm/sec.

In some embodiments, the door controller and the elevator controller determine whether the landing door can be closed normally based on the driving force of the drive mechanism and the resistance to which the car door is subjected, and subsequently send the determination result to a cloud platform (e.g., via an IoT gateway to a cluster of servers providing cloud computing services) or a mobile terminal (e.g., via a wireless signal transceiver to a mobile terminal such as a cell phone, a tablet, a portable computer, and a wearable device).

In other embodiments, the determination of the automatic closing capability of the landing door is performed at the cloud platform or the mobile terminal. In this case, the door controller or elevator controller may actively send state variables of the drive mechanism of the elevator system (e.g., induced current or output torque of the motor, etc.) to the cloud platform or the mobile terminal on a regular or irregular basis, or may provide the state variables to the cloud platform or the mobile terminal in response to a request for accessing data from the cloud platform or the mobile terminal.

In some embodiments, only when the elevator system is in a specific operating mode (e.g., a test mode), the state variables are obtained by controlling the drive mechanism when the car door and the landing door move in a uniform linear motion. It should be noted, however, that this is not the only way. In some other embodiments, the state variables of the drive mechanism when the landing door and the car door are in various operating states are stored by the door controller or the elevator controller; subsequently, the state variables corresponding to the time when the car door and the landing door move in a uniform linear motion may be extracted from the stored state variables for use in the judgment of the automatic closing capability of the landing door. Since it is no longer necessary to put the elevator system into a specific operating mode for obtaining the state variables in the state of uniform linear motion, the workload of upgrading and reconstructing the existing elevator system can be minimized to the greatest extent possible.

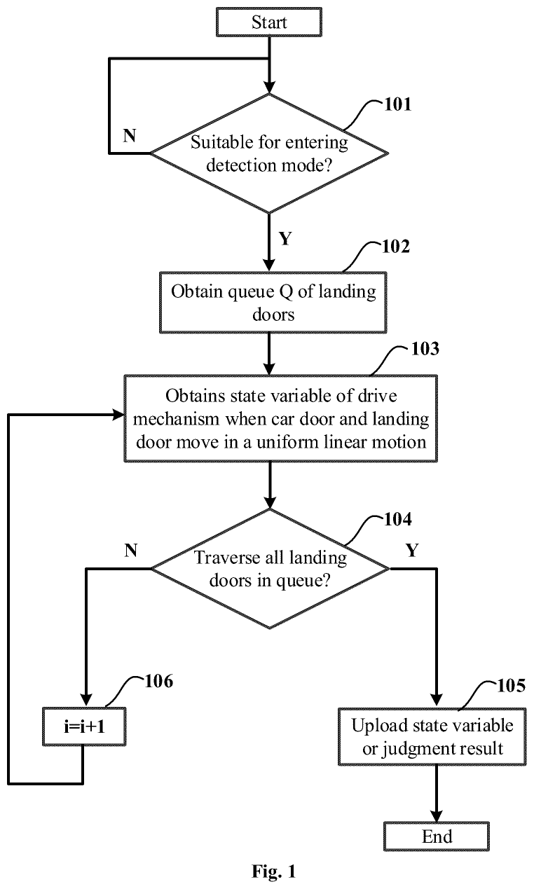

FIG. 1 is a flowchart of a method for detecting an automatic closing function of a landing door in accordance with some embodiments of the present application. The method described below may be implemented by various devices, which include, for example, but are not limited to, a control device (e.g., a door controller or an elevator controller) within an elevator system and a dedicated device for detecting the automatic closing function of the landing door, etc., which are hereinafter collectively referred to as a detection device.

The method shown in FIG. 1 begins at step 101. In this step, the detection device determines whether the elevator system is suitable for entering the detection mode at the current time. If it is suitable for entering the detection mode, it proceeds to step 102, otherwise, it continues to wait. Exemplarily, maintenance of the elevator system is typically performed during non-operational period, so the detection device may allow the elevator system to enter the detection mode when the current time is outside of the operational period and there are no calls for elevators.

At step 102, the detection device obtains a queue Q of landing doors to be performed for checking the automatic closing function of the landing door, the queue comprises one or more landing doors FDᵢ, each landing door being associated with one of a plurality of floors (e.g., provide at an associated floor). In some embodiments, the order of floors (e.g. from the 1st floor to the nth floor or from the nth floor to the 1st floor) is used as the order in which checks are performed on the landing doors. However, it should be noted that this is not necessary and other checking orders may be used as needed for application scenarios (e.g., performing the checking only for landing doors on even or odd numbered floors, or performing the checking for landing doors that are used frequently). Exemplarily, the serial number i is used to indicate the order in which the check operation of the automatic closing function of the landing door is performed.

Subsequently, the process proceeds to step 103, in which the detection device obtains a state variable VAR₁ (e.g., an induced current of the motor) of the drive mechanism of the elevator system when the car door and the ith landing door FDᵢ (i=1 when detection starts) in the queue Q of the landing doors move in a uniform linear motion during a closing process, where the subscript i corresponds to the serial number of the landing door in the queue Q.

Next, the process shown in FIG. 1 proceeds to step 104. In this step, the detection device determines whether the state variables VAR₁˜VARₙ of the drive mechanism when all the landing doors in the queue Q move in a uniform linear motion have been obtained, and proceeds to step 105 if all the landing doors in the queue Q are traversed, and otherwise, proceeds to step 106.

In step 105, the detection device sends the state variables VAR₁˜VARₙ obtained in step 104 when each landing door moves in a uniform linear motion to the cloud platform or the mobile terminal. Optionally, the movement speeds V₁˜Vₙ of the car door and the landing door at the time of obtaining the state variables may be sent together with the state variables.

In step 106, the detection device increments the serial number of the landing door (i=i+1) to cause the operation object of the subsequent step to be updated to the next landing door in the queue Q. After completing step 106, the flow shown in FIG. 1 returns to step 103 so as to perform the state variable obtaining operation on the other landing doors in the queue Q.

In a modified scheme of the embodiment shown in FIG. 1, in step 105, the detection device may judge whether each landing door in the queue can be closed normally based on the state variables VAR₁˜VARₙ obtained in step 104, and send the judgment results to the cloud platform or the mobile terminal. Exemplarily, the detection device may utilize the judgment logic based on a single threshold value described above to obtain the judgment results.

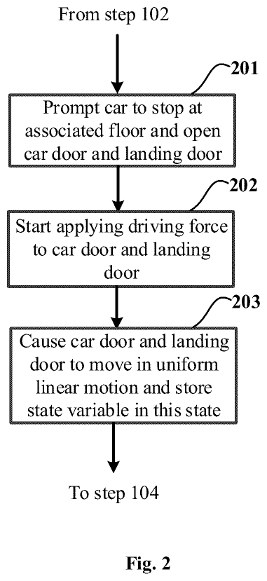

FIG. 2 is a flowchart of a method for detecting an automatic closing function of a landing door in accordance with some other embodiments of the present application. The implementation of step 103 in FIG. 1 is described further below with the aid of FIG. 2.

The flow shown in FIG. 2 begins at step 201, which follows, for example, step 102 in FIG. 1. In step 201, the detection device prompts the car to stop at the floor associated with the ith landing door FDᵢ (i=1 when detection starts) in the queue Q of landing doors, i.e., the car is stationary at that floor. Optionally, the detection device also prompts the landing door and the car door to be in the open state.

Next, in step 202, the detection device prompts the drive mechanism (e.g., a motor) to start applying a driving force to the car door CD and the ith landing door FDᵢ, thereby initiating the closing process of the car door and the ith landing door.

Then proceed to step 203, under control (e.g., by the door controller) or coordination (e.g., by the door controller based on an instruction from the elevator controller) of the detection device, the car door and the landing door are caused to move in a uniform linear motion by adjusting the driving force applied by the drive mechanism to the car door CD and the landing door FDᵢ, and a state variable VARi (e.g., induced current of the motor, etc.) of the drive mechanism at the time when the car door CD and the landing door FD; are in the state of uniform linear motion is stored. The specific implementation for causing the car door and the landing door to move in a uniform linear motion has been described above and will not be repeated here. It should be noted that the state variable VAR₁ may contain either a single sample value or several sample values for the moments t1˜tm. In the latter case, the driving force Fⁱ₂(T₁)˜Fⁱ₂(tₘ) applied by the drive mechanism at the plurality of moments when the car door CD and the landing door FD; move in uniform linear motion will be obtained from the state variable, and the average value of these driving forces may be used for the judgment of the automatic closing capability of the landing door FDᵢ (here, the superscript i corresponds to the serial number of the landing door in the queue Q).

After completion of step 203, the process shown in FIG. 2 will go, for example, to step 104 in FIG. 1.

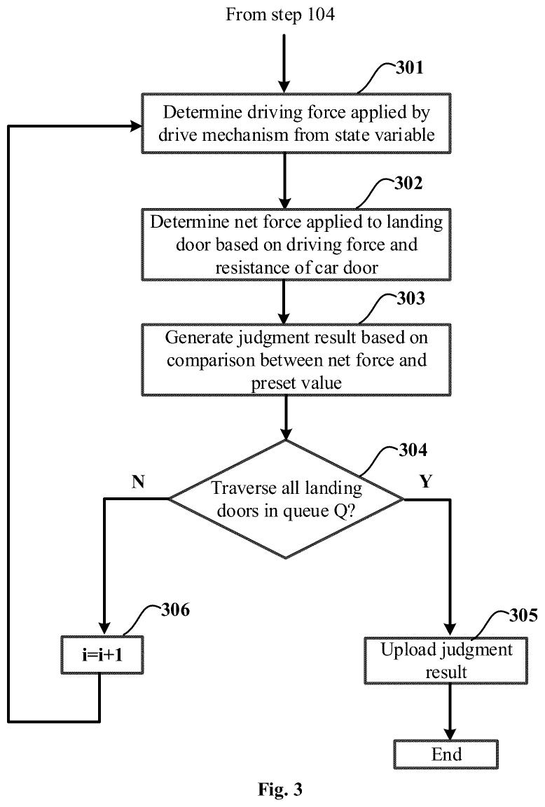

FIG. 3 is a flowchart of a method for detecting an automatic closing function of a landing door in accordance with some other embodiments of the present application. The method for determining the automatic closing capability of a landing door based on a state variable is described further in the following with the aid of FIG. 3.

The flow shown in FIG. 3 begins at step 301, which follows, for example, step 104 in FIG. 1. In step 301, the detection device determines, from the state variable VARᵢ, the driving force applied by the drive mechanism when the car door CD and the landing door FDᵢ (i=1 when detection starts) move in uniform linear motion. For example, when the drive mechanism is realized using a motor, the driving force Fⁱ₂ applied by the motor to the car door and the landing door may be obtained from the induced current as the state variable VARᵢ based on the correspondence (e.g., proportionality) between the induced current and the output torque of the motor, where the superscript i corresponds to the serial number of the landing door in the queue Q. As described above, when the state variable VARᵢ contains sampled values of a plurality of moments, the average value of the driving force Fⁱ₂(T₁)˜Fⁱ₂(tₘ) applied at the plurality of moments may be used as the driving force Fⁱ₂ applied by the motor to the car door and the landing door.

Subsequently, proceeding to step 302, the detection device determines a net force Finet applied to the landing door FDᵢ based on the driving force Fⁱ₂ determined in step 301 and the resistance f_{car} to which the car door CD is subjected to during its travel as calibrated by experimentation, where the superscript i corresponds to the serial number of the landing door in the queue Q. The specific determination may for example utilize the equation (2) above.

After step 302, the process shown in FIG. 3 proceeds to step 303. In this step, the detection device determines whether the net force Finet is greater than or equal to the preset value TH, and if so, assigns the landing door FDᵢ with the flag TRUE for being able to be closed normally, and otherwise assigns the landing door FDᵢ with the flag FALSE for not being able to be closed normally. Optionally, the corresponding preset value THᵢ may be set for each landing door to reflect differences in the automatic closing capability requirements of the landing doors.

After performing step 303, the process shown in FIG. 3 proceeds to step 304. In this step, the detection device determines whether a judgment operation has been performed for all the landing doors in the queue Q. If all the landing doors in the queue Q are traversed, it proceeds to step 305, otherwise, it proceeds to step 306.

In step 305, the detection device sends the judgment result regarding the automatic closing capability of the landing doors FD₁˜FDRₙ to the cloud platform or the mobile terminal.

In step 306, the detection device increments the serial number of the landing door (i=i+1) to cause the operation object of the subsequent step to be updated to the next landing door in the queue Q. After completing step 306, the flow shown in FIG. 3 returns to step 301 so as to perform the state variable obtaining operation on the other landing doors in the queue Q.

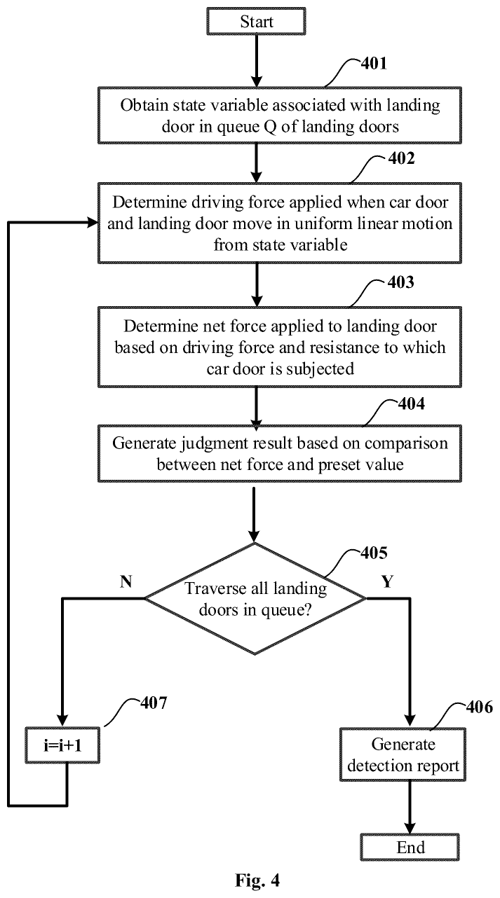

FIG. 4 is a flowchart of a method for detecting an automatic closing function of a landing door in accordance with some other embodiments of the present application. The method described below may be realized at a cloud platform or a mobile terminal.

The method shown in FIG. 4 begins at step 401. In this step, the cloud platform or the mobile terminal obtains a state variable associated with each of the landing doors in the queue Q of landing doors. In some embodiments, the state variables are state variables of the drive mechanism when the car door and the landing door are in a state of uniform linear motion (e.g., state variables VAR₁ to VARₙ obtained with the help of the implementation shown in FIG. 2). In some other embodiments, the cloud platform or the mobile terminal may extract the state variables (also denoted as VAR₁˜VARₙ for convenience) corresponding to the time when the car door and the landing door move in a uniform linear motion from the set of state variables of the drive mechanism provided by the elevator system in various motion states of the car door and the landing door.

Subsequently, proceeding to step 402. In this step, the cloud platform or the mobile terminal determines, from the state variable VARᵢ, a driving force applied by the drive mechanism when the landing door FDᵢ (i=1 when detection starts) moves in uniform linear motion. The manner in which the driving force Fⁱ₂ applied by the motor to the car door and the landing door is determined by the state variable VARᵢ has been described above and will not be repeated here.

Next, the process shown in FIG. 4 proceeds to step 403. In this step, the cloud platform or the mobile terminal determines a net force Finet applied to the landing door based on the driving force Fi2 determined in step 402 and the resistance f_{car} to which the car door CD is subjected to during its travel as calibrated by experimentation. The specific manner in which the net force Fⁱₙₑₜ is determined has been described above, and will not be repeated herein. The calibrated resistance f_{car} may be sent by the elevator system to the cloud platform or the mobile terminal regularly or irregularly, or it may be called by the cloud platform or the mobile terminal by accessing the elevator system.

Subsequently, proceeding to step 404, the cloud platform or the mobile terminal compares the net force Finet with the preset value TH, and if it is greater than or equal to the preset value TH, assigns the landing door FDᵢ with the flag TRUE for being able to be closed normally, and otherwise assigns the landing door FDᵢ with the flag FALSE for not being able to be closed normally.

After executing step 404, the process shown in FIG. 4 proceeds to step 405. In this step, the cloud platform or the mobile terminal determines whether a judgment operation has been performed for all the landing doors in the queue Q. If all the landing doors in the queue Q are traversed, it proceeds to step 406, otherwise, it proceeds to step 407.

In step 406, the cloud platform or the mobile terminal will generate a detection report on the automatic closing capability of each of the landing doors in the queue Q.

In step 407, the cloud platform or mobile terminal increments the serial number of the landing door (i=i+1) to cause the operation object of the subsequent step to be updated to the next landing door in the queue Q. After completing step 407, the flow shown in FIG. 4 returns to step 402 so as to perform the state variable obtaining operation on the other landing doors in the queue Q.

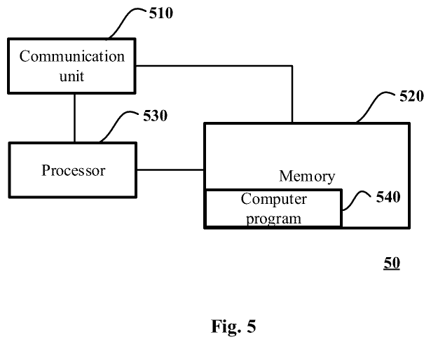

FIG. 5 is a schematic block diagram of a device for detecting an automatic closing function of a landing door in accordance with some other embodiments of the present application. The device shown in FIG. 5 may be one of a cloud platform, an elevator controller, a door controller, and a mobile terminal.

As shown in FIG. 5, a device 50 comprises a communication unit 510, one or more memories 520 (e.g., a non-volatile memory such as a flash memory, a ROM, a hard drive, a disk, an optical disc), one or more processors 530, and a computer program 540 stored on the one or more memories 520.

The communication unit 510 (e.g., a network interface card) serves as a communication interface configured to establish a communication connection between the device 50 and an external device (e.g., a drive mechanism for a car door, etc.) or a network (e.g., Internet and wireless LAN, etc.).

The memory 520 stores the computer program 540 that may be executed by the processor 530 (e.g., a microprocessor configured to execute the operations disclosed herein in response to the computer program 540). In addition, the memory 520 may also store data generated by the processor 530 in execution of the computer program 540 and data received from an external device via the communication unit 510 (e.g., a queue Q of landing doors to be performed for checking the automatic closing function, a state variable of the drive mechanism, a calibrated value of the resistance to which the car door is subjected, and the detection result of the automatic closing function, etc.).

The processor 530 is configured to run the computer program 540 stored on the memory 520 and to perform access operations to the memory 520 (e.g., obtaining the queue Q of landing doors, the state variables of the drive mechanism, the calibrated value of the resistance to which the car door is subjected, and storing, for example, the detection result of the automatic closing function, etc., in the memory 520, etc.).

The computer program 540 may include computer instructions for implementing the methods described with the aid of FIGS. 1 to 4, enabling the corresponding methods to be implemented when the computer program 540 is run on the processor 530.

Those skilled in the art will appreciate that various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will appreciate that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. A method for detecting an automatic closing function of one or more landing doors, for each landing door to be detected, the method comprising:
A. obtaining a state variable of a drive mechanism of the elevator system when a car door of a car of an elevator system and the landing door to be detected move in a uniform linear motion during a closing process, the state variable being suitable for determining a driving force applied by the drive mechanism to the car door and the landing door to be detected;
B. determining automatic closing capability of the landing door to be detected based on the driving force applied during the uniform linear motion and resistance to which the car door is subjected when traveling.

2. The method of claim 1, further comprising: determining whether the elevator system is suitable for entering or being in a detection mode, and if so, performing steps A and B.

3. The method of claim 1, further comprising: sending a detection result regarding the automatic closing capability of the landing door to be detected to a cloud platform or a mobile terminal.

4. The method of claim 1, wherein steps A and B are performed for a plurality of landing doors in a specified order.

5. The method of claim 1, wherein step A comprises:
A1. opening the car door of the car and the landing door to be detected when the car stops at one of a plurality of floors corresponding to the landing door to be detected;
A2. causing the car door and the landing door to be detected to move in the uniform linear motion during the closing process by controlling the driving force applied by the drive mechanism to the car door and the landing door to be detected.

6. The method of claim 1, wherein step A comprises receiving, from the elevator system, the state variable of the drive mechanism when the car door and the landing door to be detected move in the uniform linear motion.

7. The method of claim 1, wherein step A comprises:
A3. receiving, from the elevator system, state variables of the drive mechanism under various motion states of the car door and the landing door to be detected;
A4. extracting the state variable when the car door and the landing door to be detected move in the uniform linear motion from the state variables under the various motion states.

8. The method of claim 5, wherein step B is performed at any of the following locations: a cloud platform, an elevator controller, a door controller and a mobile terminal.

9. The method of claim 1, wherein a speed of the uniform linear motion is controlled in a range of 20 mm/sec to 80 mm/sec.

10. The method of claim 5, wherein the drive mechanism is a motor, and in step A2, the uniform linear motion of the car door and the landing door to be detected is realized by causing the motor to work in a constant-speed output mode.

11. The method of claim 10, wherein the state variable when the car door and the landing door to be detected move in the uniform linear motion and the state variable under various motion states are an induced current or an output torque of the motor.

12. The method of claim 1, wherein the resistance is determined in the following manner:
decoupling the car door and the landing door to be detected from mechanical coupling;
placing the car door in a state of the uniform linear motion by controlling the driving force applied by the drive mechanism to the car door; and
determining the resistance based on the driving force applied to the car door in the state of the uniform linear motion.

13. The method of claim 1, wherein the automatic closing capability is measured in terms of a net force applied to the landing door to be detected.

14. The method of claim 13, wherein in step B, the automatic closing capability of the landing door to be detected is determined in the following manner:
B1. determining, from the state variable, the driving force applied by the drive mechanism when the landing door to be detected moves in the uniform linear motion;
B2. determining the net force based on the driving force applied by the drive mechanism when the landing door to be detected moves in the uniform linear motion and the resistance to which the car door is subjected when traveling; and
B3. determining that the landing door to be detected can be closed normally if the net force is greater than or equal to a preset value, otherwise determining that the landing door to be detected cannot be closed normally.

15. The method of claim 14, wherein in step B1, an average value of the driving force applied by the drive mechanism at a plurality of moments when the car door and the landing door to be detected move in the uniform linear motion is used as the driving force for determining the net force.

16. A device for detecting an automatic closing function of one or more landing doors, comprising:
at least one memory;
at least one processor coupled with the memory; and
a computer program stored on the memory and running on the processor, the running of the computer program resulting in the following operations:
A. obtaining a state variable of a drive mechanism of the elevator system when a car door of a car of an elevator system and a landing door to be detected move in a uniform linear motion during a closing process, the state variable being suitable for determining a driving force applied by the drive mechanism to the car door and the landing door to be detected;
B. determining automatic closing capability of the landing door to be detected based on the driving force applied during the uniform linear motion and resistance to which the car door is subjected when traveling.

17. The device of claim 16, wherein the running of the computer program also results in the further operation of: determining whether the elevator system is suitable for entering or being in a detection mode, and if so, performing steps A and B.

18. The device of claim 16, wherein the running of the computer program causes steps A and B to be performed for a plurality of landing doors in a specified order.

19. The device of claim 16, wherein the device is one of the following: a cloud platform, a mobile terminal, a door controller and an elevator controller.

20. The device of claim 16, wherein the running of the computer program also results in the further operation of: sending a detection result regarding the automatic closing capability of the landing door to be detected to a cloud platform or a mobile terminal.

21. The device of claim 16, wherein the running of the computer program results in step A being performed in the following manner:
A1. opening the car door of the car and the landing door to be detected when the car stops at one of a plurality of floors corresponding to the landing door to be detected;
A2. causing the car door and the landing door to be detected to move in the uniform linear motion during the closing process by controlling the driving force applied by the drive mechanism to the car door and the landing door to be detected.

22. The device of claim 16, wherein the running of the computer program results in step A being performed in the following manner: receiving, from the elevator system, the state variable of the drive mechanism when the car door and the landing door to be detected move in the uniform linear motion.

23. The device of claim 16, wherein the running of the computer program results in step A being performed in the following manner:
A3. Receiving, from the elevator system, state variables of the drive mechanism under various motion states of the car door and the landing door to be detected;
A4. extracting the state variable when the car door and the landing door to be detected move in the uniform linear motion from the state variables under the various motion states.

24. The device of claim 16, wherein a speed of the uniform linear motion is controlled in a range of 20 mm/sec to 80 mm/sec.

25. The device of claim 21, wherein the drive mechanism is a motor, the running of the computer program results in step A2 being performed in the following manner:
the uniform linear motion of the car door and the landing door to be detected is realized by causing the motor to work in a constant-speed output mode.

26. The device of claim 25, wherein the state variable when the car door and the landing door to be detected move in the uniform linear motion and the state variable under various motion states are an induced current or an output torque of the motor.

27. The device of claim 16, wherein the resistance is calibrated in the following manner:
decoupling the car door and the landing door from mechanical coupling;
causing the car door to move in the uniform linear motion by controlling the driving force applied by the drive mechanism to the car door; and
determining the resistance based on the driving force at the uniform linear motion of the car door.

28. The device of claim 16, wherein the automatic closing capability is measured in terms of a net force applied to the landing door to be detected.

29. The device of claim 28, wherein the running of the computer program results in step B being performed in the following manner:
B1. determining, from the state variable, the driving force applied by the drive mechanism when the landing door to be detected moves in the uniform linear motion;
B2. determining the net force based on the driving force applied by the drive mechanism when the landing door to be detected moves in the uniform linear motion and the resistance to which the car door is subjected when traveling; and
B3. determining that the landing door to be detected can be closed normally if the net force is greater than or equal to a preset value, otherwise determining that the landing door to be detected cannot be closed normally.

30. The device of claim 29, wherein in step B1, an average value of the driving force applied by the drive mechanism at a plurality of moments when the car door and the landing door to be detected move in the uniform linear motion is used as the driving force for determining the net force.

31. A non-transitory computer-readable storage medium, the computer-readable storage medium having instructions stored therein, characterized in that when the instructions are executed by a processor, the processor performs the method of claim 1.
